(19) United States
(12) Patent Application Publication
(10) Pub. No.: US 2025/0115686 A1
(43) Pub. Date: Apr. 10, 2025

(54) OLEFIN POLYMERIZATION CATALYST COMPONENTS CONTAINING SILANE AND PROCESS FOR THE PRODUCTION OF POLYPROPYLENE HAVING HIGH ISOTACTICITY AT HIGH MELT FLOW RATE

(71) Applicant: Formosa Plastics Corporation, U.S.A., Livingston Township, NJ (US)

(72) Inventors: Gapgoung Kong, Sugarland, TX (US); Cyrus C.Y. Lee, Victoria, TX (US); Chih-Jian Chen, Port Lavaca, TX (US)

(21) Appl. No.: 18/483,221

(22) Filed: Oct. 9, 2023

(51) Int. Cl. C08F 4/649

(52) U.S. Cl. CPC C08F 4/6495; C08F 4/6494; C08F 4/6498; C08F 2410/04

(57) ABSTRACT

The present invention relates to a solid Ziegler-Natta catalyst component for use in olefin polymerization. The catalyst component comprises magnesium, titanium, halide, one or more dicylopentyldialkoxysilane compounds, one or more dialkylaminotrialkoxysilane compounds, and one or more internal electron donors comprising urea, phthalate and 1,3-diether. The catalyst components, according to present invention, are able to produce polypropylene polymers having high isotacticity with high melt flow rate.

### BACKGROUND

The present invention relates to a solid Ziegler-Natta catalyst component for olefin polymerization prepared in the presence of a combination of dicyclopentyldialkoxysilane and dialkyaminotrialkoxysilane, and internal donors comprising urea, phthalate and 1,3-diether. The present invention also relates to methods of making polymerization catalyst systems utilizing these catalyst components, which can produce polypropylene having high isotacticity and high melt flow rate.

Ziegler-Natta catalyst systems for polyolefin polymerization are well known in the art. Commonly, these systems are composed of a solid Ziegler-Natta catalyst component and a co-catalyst component, usually an organoaluminum compound, and/or an external electron donor to be used in conjunction. Solid Ziegler-Natta catalyst components typically include magnesium, halide, titanium, and internal electron donor compounds which have been widely employed to increase the activity and stereo-specificity of polymerization catalyst system.

Common internal electron donor compounds, which are incorporated in the solid Ziegler-Natta catalyst component during preparation of such component, are well known in the art and include ethers, ketones, amines, alcohols, heterocyclic organic compounds, phenols, phosphines, and silanes. It is well known in the art that polymerization activity, as well as stereoregularity, molecular weight, and molecular weight distribution of the resulting polymer depend on the molecular structure of the internal electron donor employed. Therefore, in order to improve the polymerization process and the properties of the resulting polymer, there has been an effort and desire to develop various internal electron donors. Examples of such internal electron donor compounds and their use as a component of the catalyst system are described in U.S. Pat. Nos. 4,107,414; 4,186,107; 4,226,963; 4,347,160; 4,382,019; 4,435,550; 4,465,782; 4,522,930; 4,530,912; 4,532,313; 4,560,671; 4,657,882; 5,208,302; 5,902,765; 5,948,872; 6,048,818; 6,121,483; 6,281,301; 6,294,497; 6,313,238; 6,395,670; 6,436,864; 6,605,562; 6,716,939; 6,770,586; 6,818,583; 6,825,309; 7,022,640; 7,049,377; 7,202,314; 7,208,435; 7,223,712; 7,351,778; 7,371,802; 7,491,781; 7,544,748; 7,674,741; 7,674,943; 7,888,437; 7,888,438; 7,935,766; 7,964,678; 8,003,558; 8,003,559; 8,088,872; 8,211,819; 8,222,357; 8,227,370; 8,236,908; 8,247,341; 8,263,520; 8,263,692; 8,288,304; 8,288,585; 8,288,606; 8,318,626; 8,383,540; 8,536,290 8,569,195; 8,575,283; 8,604,146; 8,633,126; 8,692,927; 8,664,142; 8,680,222; 8,716,514; and 8,742,040, each of which is incorporated by reference herein in its entirety.

Meanwhile, there has been demand for polypropylene material having high stiffness and high melt flow rate. U.S. Pat. No. 7,465,776 introduced a catalyst component containing phthalate and diether as an internal donor component producing polypropylene having high isotacticity and high melt flow rate. U.S. Pat. Nos. 5,652,303 and 6,087,459 each describes blending two external donors of trialkoxysilane compounds and dicyclopentyldimethoxysilane in a polymerization process to prepare broad MWD polypropylene. Also, U.S. Pat. No. 9,815,920 describes a urea component employed as an internal donor component in combination with one or more internal electron donors to improve isotacticity for higher stiffness.

There is still a need of development for catalyst system that can produce polypropylene having high melt flow rate and high isotacticity with high activity.

### SUMMARY OF THE INVENTION

It is therefore an object of present invention to provide a method of preparing a Ziegler-Natta catalyst components for producing polypropylene having high melt flow rate and high isotacticity with higher activity, wherein the catalyst is prepared via contact reaction between magnesium, halide and titanium compound in the presence of a combination of dicyclopentyldialkoxysilane and dialkyaminotrialkoxysilane, and internal donors comprising urea, phthalate and 1,3-diether.

According to present invention, dicyclopentyldialkoxysilane is selected from compound represented by Formula I, dialkyaminotrialkoxysilane is selected from compounds represented by Formula II, and urea is selected from the compound represented by Formula III.

R₂Si(OR¹)₂ [Formula I]

wherein R is cyclopentyl or its derivatives, and R¹ is aliphatic hydrocarbon having 1 to 20 carbon atoms;

(R²)₂NSi(OR³)₃ [Formula II]

wherein R² and R³ are aliphatic hydrocarbons having 1 to 20 carbon atoms; and

R⁴(R⁵)N(C═O)N(R⁶)R⁷ [Formula III]

wherein R⁴, R⁵, R⁶, and R⁷, which may be identical or different, are independently selected from hydrogen, an aliphatic hydrocarbon group having 1 to 20 carbon atoms, an alicyclic hydrocarbon group having 3-20 carbon atoms, an aromatic hydrocarbon group having 6-20 carbon atoms, or a heteroatom-containing hydrocarbon group having 1 to 20 carbon atoms, wherein two or more of R⁴, R⁵, R⁶, and R⁷ may be linked to form one or more saturated or unsaturated monocyclic or polycyclic rings.

### DESCRIPTION OF PREFERRED EMBODIMENTS

In accordance with the present invention, a solid catalyst component (A) for the production of polyolefins, particularly polypropylene, are prepared in the presence of a combination of dicyclopentyldialkoxysilane and dialkyaminotrialkoxysilane, employed as elements of solid Ziegler-Natta catalyst component (A) in conjunction with internal donors comprising urea, phthalate and 1,3-diether donors.

According to certain aspects of the present invention, the dicyclopentyldialkoxysilane compounds that may be employed as an element of solid catalyst composition are represented by Formula I:

R₂Si(OR¹)₂ [Formula I]

wherein R is cyclopentyl or its derivatives, and R¹ is aliphatic hydrocarbon having 1 to 20 carbon atoms. Preferred examples of Formula I compounds include, but are not limited to: dicyclopentyldimethoxysilane, dicyclopentyldiethoxysilane, dimethylcyclopentyldimethoxysilane, and dicyclopentyldiethoxysilane.

According to certain aspects of the present invention, the dialkyaminotrialkoxysilane compounds that may be employed as an element of solid catalyst composition are represented by Formula II:

(R²)₂NSi(OR³)₃ [Formula II]

wherein R² and R³ are aliphatic hydrocarbons having 1 to 20 carbon atoms. Preferred examples of Formula II compounds include, but are not limited to: diethylaminotriethoxysilane, dipropylaminotriethoxysilane, and diethylaminotrimethoxysilane.

The urea compounds that may be employed as an element of solid catalyst composition according to present invention, are represented by Formula III:

R⁴(R⁵)N(C═O)N(R⁶)R⁷ [Formula III]

wherein R⁴, R⁵, R⁶, and R⁷, which may be identical or different, are independently selected from hydrogen, an aliphatic hydrocarbon group having 1 to 20 carbon atoms, an alicyclic hydrocarbon group having 3-20 carbon atoms, an aromatic hydrocarbon group having 6-20 carbon atoms, or a heteroatom-containing hydrocarbon group having 1 to 20 carbon atoms, wherein two or more of R⁴, R⁵, R⁶, and R⁷ may be linked to form one or more saturated or unsaturated monocyclic or polycyclic rings. Preferred examples of Formula III compounds include, but are not limited to: N,N,N′,N′-tetramethylurea, N,N,N′,N′-tetraethylurea, N,N,N′,N′-tetrapropylurea, N,N,N′-tetrabutylurea, N,N,N′,N′-tetrapentylurea, N,N,N′,N′-tetrahexylurea, N,N,N′,N′-tetra(cyclopropyl)urea, N,N,N′,N′-tetra(cyclohexyl)urea, N,N,N,N′-tetraphenylurea, bis(butylene)urea, bis(pentylene)urea, N,N′-dimethylethyleneurea, N,N′-dimethylpropyleneurea, N,N′-dimethyl(2-(methylaza)propylene)urea and N,N′-dimethyi(3-(methylaza)pentylene)urea. n-amyltriphenyhureai, n-hexyltriphenylurea, n-octyltriphenylurea, n-decyltriphenylurea, n-octadecyltriphenylurea, n-butyltritolylurea, n-butyltrinaphthylurea; n-hexyltrimethylurea, n-hexyltriethylurea, noctyltrimethylurea, dihexyldimethylurea, dihexyldiethylurea, trihexylmethylurea, tetrahexylurea; n-butyltricyclohexylurea, t-butyltriphenylurea; 1,1-bis(p-biphenyl)-3-methyl-3-n-octadecylurea; 1,1-di-n-octadecyl-3-t-butyl-3-phenylurea; 1-p-biphenyl-1-methyl-3-noctadecyl 3 phenylurea; 1-methyl-1-n-octadecyl-3 p-biphenyl-3-o-tolylurea; i-terphenyl-tri-t-butylurea, 1,3-dimethyl-2-imidazolidinone, 1,3-diethyl-2-imidazolidinone, 1,3-dipropyl-2-imidazolidinone, 1,3-dibutyl-2-imidazolidinone, 1,3-dimethyl-3,4,5,6-tetrahydro-2-pyrimidinone, and N,N-dimethyl-N,N,-diphenylurea,

A mixture of dicyclopentyldialkoxysilane and dialkyaminotrialkoxysilane can be employed as an element of Ziegler Natta catalyst with magnesium halide, titanium and internal donors preferably in the ratio of about 0.01 to about 0.5 mol per mol of magnesium, more preferably in the ratio of about 0.01 to about 0.1 mol per mol of magnesium. Urea compounds are employed as an element of Ziegler Natta catalyst with magnesium halide, titanium and internal donors in the ratio of about 0.01 to about 0.5 mol per mol of magnesium, more preferably in the ratio of about 0.01 to about 0.1 mol per mol of magnesium.

According to certain aspects of the present invention, phthalate compounds that may be employed as an element of solid catalyst component (A) are ester forms of any phthalic acid compounds. Preferred examples of phthalate that can be used in conjunction with alkyltrialkoxysilane, urea compound, and 1,3-diether include, but are not limited to: diethylphthalate, di-n-propylphthalate, di-n-butylphthalate, di-n-pentylphthalate, di-i-pentylphthalate, bis(2-ethylhexyl)phthalate, ethylisobutylphthalate, ethyl-n-butylphthalate, di-n-hexylphthalate, and di-isobutylphthalate.

Preferred examples of 1,3-diethers that can be used according to the present invention include, but are not limited to: 2-(2-ethylhexyl)_{1,3}-dimethoxypropane, 2-isopropyl-1,3-dimethoxypropane, 2-butyl-1,3-dimethoxypropane, 2-sec-butyl-1,3-dimethoxypropane, 2-cyclohexyl-1,3-dimethoxypropane, 2-phenyl-1,3-dimethoxypropane, 2-tert-butyl-1,3-dimethoxypropane, 2-cumyl-1,3-dimethoxypropane, 2-(2-phenylethyl)-1,3-dimethoxypropane, 2,2-diethyl-1,3-diethoxypropane, 2,2-dicyclopentyl-1,3-dimethoxypropane, 2,2-dipropyl-1,3-diethoxypropane, 2,2-dibutyl-1,3-diethoxypropane, 2-methyl-2-ethyl-1,3-dimethoxypropane, 2-methyl-2-propyl-1,3-dimethoxypropane, 2-methyl-2-benzyl-1,3-dimethoxypropane, 2,2-diphenyl-1,3-dimethoxypropane, 2,2-dibenzyl-1,3-dimethoxypropane, 2-isopropyl-2-cyclopentyl-1,3-dimethoxypropane, 2,2-bis(cyclohexylmethyl)-1,3-dimethoxypropane, 2,2-diisobutyl-1,3-diethoxypropane, 2,2-diisobutyl-1,3-dibutoxypropane, 1,1-bis(methoxymethyl)-7-(3,3,3-trifluoropropyl)indene, 1,1-bis(methoxymethyl)-7-trimethyisilylindene; 1,1-bis(methoxymethyl)-7-trifluoromethylindene, 1,1-bis(methoxymethyl)-4,7-dimethyl-4,5,6,7-tetrahydroindene, 1,1-bis(methoxymethyl)-7-methylindene, 1,1-bis(methoxymethyl)-1H-benz[e]indene, 1,1-bis(methoxymethyl)-1H-2-methylbenz[e]indene, 9,9-bis(methoxymethyl)fluorene, 9,9-bis(methoxymethyl)-2,3,6,7-tetramethylfluorene, 9,9-bis(methoxymethyl)-2,3,4,5,6,7-hexafluorofluorene, 9,9-bis(methoxymethyl)-2,3-benzofluorene, 9,9-bis(methoxymethyl)-2,3,6,7-dibenzofluorene, 9,9-bis(methoxymethyl)-2,7-diisopropylfluorene, 9,9-bis(methoxymethyl)-1,8-dichlorofluorene, 9,9-bis(methoxymethyl)-2,7-dicyclopentylfluorene, 9,9-bis(methoxymethyl)-1,8-difluorofluorene, 9,9-bis(methoxymethyl)-1,2,3,4-tetrahydrofluorene, 9,9-bis(methoxymethyl)-1,2,3,4,5,6,7,8-octahydrofluorene, and 9,9-bis(methoxymethyl)-4-tert-butylfluorene.

Acceptable anhydrous magnesium dihalides forming the support for the solid Ziegler-Natta type catalyst component (A) are the magnesium dihalides in active form that are well known in the art. Such magnesium dihalides may be preactivated, may be activated in situ during titanation, may be formed in-situ from a magnesium compound, which is capable of forming magnesium dihalide when treated with a suitable halogen-containing transition metal compound, and then activated. Preferred magnesium dihalides are magnesium dichloride and magnesium dibromide. The water content of the dihalides is generally less than 1% by weight.

The solid Ziegler-Natta type catalyst component (A) may be made by various methods. One such method consists of co-grinding the magnesium dihalide and the internal electron donor compound until the product shows a surface area higher than 20 m²/g and thereafter reacting the ground product with the Ti compound. Other methods of preparing solid Ziegler-Natta type catalyst component are disclosed in U.S. Pat. Nos. 4,220,554; 4,294,721; 4,315,835; 4,330,649; 4,439,540; 4,816,433; and 4,978,648, each of which is incorporated herein by reference in its entirety.

In a typical modified solid Ziegler-Natta type catalyst component, the molar ratio between the magnesium dihalide and the halogenated titanium compound is between about 1 and about 500, the molar ratio between said halogenated titanium compound and the internal electron donor is between about 0.1 and about 50, and the molar ratio between said internal electron donor and the oxalic acid diamide modifier is between about 0.1 and about 100.

Preferred co-catalyst component (B) includes aluminum alkyl compounds. Preferred aluminum alkyl compounds include aluminum trialkyls, such as aluminum triethyl, aluminum triisobutyl, and aluminum triisopropyl. Other acceptable aluminum alkyl compounds include aluminum-dialkyl hydrides, such as aluminum-diethyl hydrides. Other acceptable co-catalyst component include compounds containing two or more aluminum atoms linked to each other through hetero-atoms, such as:

(C₂H₅)₂Al—O—Al(C₂H₅)₂

(C₂H₅)₂Al—N(C₆H₅)—Al(C₂H₅)₂

(C₂H₅)₂Al—O—SO₂—O—Al(C₂H₅)₂

Acceptable external electron donor component (C) is organic compounds containing O, Si, N, S, and/or P. Such compounds include organic acids, organic acid esters, organic acid anhydrides, ethers, ketones, alcohols, aldehydes, silanes, amides, amines, amine oxides, thiols, various phosphorus acid esters and amides, etc. Preferred external electron donor component is organosilicon compounds containing Si—O—C and/or Si—N—C bonds. Special examples of such organosilicon compounds are trimethylmethoxysilane, diphenyldimethoxysilane, cyclohexylmethyldimethoxysilane, diisopropyldimethoxysilane, dicyclopentyldimethoxysilane, isobutyltriethoxysilane, vinyltrimethoxysilane, dicyclohexyldimethoxysilane, 3-tert-Butyl-2-isobutyl-2methoxy-[1,3,2]oxazasilolidine, 3-tert-Butyl-2-cyclopentyl-2-methoxy-[1,3,2]oxazasilolidine, 2-Bicyclo[2.2.1]hept-5-en-2-yl-3-tert-butyl-2-methoxy-[1,3,2]oxazasilolidine, 3-tert-Butyl-2,2-diethoxy-[1,3,2]oxazasilolidine, 4,9-Di-tert-butyl-1,6-dioxa-4,9-diaza-5-sila-spiro[4.4]nonane, and bis(perhydroisoquinolino)dimethoxysilane. Mixtures of organic electron donors may also be used. Finally, the oxalic acid diamides of the present invention may also be employed as an external electronic donor.

The olefin polymerization processes that may be used in accordance with the present invention are not generally limited. For example, the catalyst components (A), (B), and (C) described above, when employed, may be added to the polymerization reactor simultaneously or sequentially. It is preferred to mix components (B) and (C) first, and then contact the resultant mixture with component (A) prior to the polymerization.

The olefin monomer may be added prior to, with, or after the addition of the Ziegler-Natta type catalyst system to the polymerization reactor. It is preferred to add the olefin monomer after the addition of the Ziegler-Natta type catalyst system. The molecular weight of the polymers may be controlled in a known manner, preferably by using hydrogen. With the catalysts produced according to the present invention, molecular weight may be suitably controlled with hydrogen when the polymerization is carried out at relatively low temperatures, e.g., from about 30° C. to about 105° C. This control of molecular weight may be evidenced by a measurable positive change of the Melt Flow Rate.

The polymerization reactions may be carried out in slurry, liquid or gas phase processes, or in a combination of liquid and gas phase processes using separate reactors, all of which may be done either by batch or continuously. The polyolefin may be directly obtained from gas phase process, or obtained by isolation and recovery of solvent from the slurry process, according to conventionally known methods.

There are no particular restrictions on the polymerization conditions for production of polyolefins by the method of this invention, such as the polymerization temperature, polymerization time, polymerization pressure, monomer concentration, etc. The polymerization temperature is generally from 40-90° C. and the polymerization pressure is generally 1 atmosphere or higher.

The Ziegler-Natta type catalyst systems of the present invention may be pre-contacted with small quantities of olefin monomer, well known in the art as pre-polymerization, in a hydrocarbon solvent at a temperature of 60° C. or lower for a time sufficient to produce a quantity of polymer from 0.5 to 3 times the weight of the catalyst. If such a pre-polymerization is done in liquid or gaseous monomer, the quantity of resultant polymer is generally up to 1000 times the catalyst weight.

The Ziegler-Natta type catalyst systems of the present invention are useful in the polymerization of olefins, including but not limited to homo-polymerization and copolymerization of alpha olefins. Suitable α-olefins that may be used in a polymerization process in accordance with the present invention include olefins of the general formula CH₂═CHR, where R is H or C₁₋₁₀ straight or branched alkyl, such as ethylene, propylene, butene-1, pentene-1,4-methylpentene-1 and octene-1. While the Ziegler-Natta type catalyst systems of the present invention may be employed in processes in which ethylene is polymerized, it is more desirable to employ the Ziegler-Natta type catalyst systems of the present invention in processes in which polypropylene or higher olefins are polymerized. Processes involving the homopolymerization or copolymerization of propylene are preferred.

### EXAMPLES

In order to provide a better understanding of the foregoing, the following non-limiting examples are offered. Although the examples may be directed to specific embodiments, they are not to be viewed as limiting the invention in any specific respect. The activity values (AC) are based upon grams of polymer produced per gram of solid catalyst component used.

The following analytical methods are used to characterize the polymer.

Heptane Insolubles (% HI): The weight percent (wt %) of residuals of polypropylene sample after extracted with boiling heptane for 8 hours.

Melt Flow Rate (MI): ASTM D-1238, determined at 230° C. under the load of 2.16 kg.

Tₘ: ASTM D-3417, determined by DSC (Manufacturer: TA Instrument, Inc; Model: DSC Q1000).

Determination of Isotactic Pentads Content: Place 400 mg of polymer sample into 10 mm NMR tube. 1.7 g TCE-d2 and 1.7 g o-DCB were added into the tube. ¹³C NMR spectra were acquired on a Bruker AVANCE 400 NMR (100.61 MHz, 900 pulse, 12 s delay between pulse). About 5000 transients were stored for each spectrum; mmmm pentad peak (21.09 ppm) was used as reference. The microstructure analysis was carried out as described in Macromolecules, 1994, 27, 4521-4524, by V. Busico, et al.

Molecular weight (Mn and Mw): The weight average molecular weight (Mw), number average molecular weight (Mn), and molecular weight distribution (Mw/Mn) of polymers were obtained by gel permeation chromatography on Water 2000GPCV system using Polymer Labs Plgel 10 um MIXED-B LS 300×7.5 mm columns and 1,2,4-trichlorobenzene (TCB) as mobile phase. The mobile phase was set at 0.9 ml/min, and temperature was set at 145° C. Polymer samples were heated at 150° C. for two hours. Injection volume was 200 microliters. External standard calibration of polystyrene standards was used to calculate the molecular weight.

Magnesium ethoxide (98%), anhydrous toluene (99.8%), TiCl₄ (99.9%), anhydrous n-heptane (99%), diisobutyl phthalate (99%), cyclohexyl(dimethoxy)methylsilane (C-donor, ≥99%) and triethylaluminum (93%) were all purchased from Sigma-Aldrich Co. of Milwaukee, WI, USA.

Diisopropyldimethoxysilane (P-donor) and dicyclopentyldimethoxysilane (D-donor) were purchased from Gelest, Inc. of Morrisville, PA, USA.

Unless otherwise indicated, all reactions were conducted under an inert atmosphere.

### Example 1

### (A) The Preparation of a Solid Catalyst Component

To a three-neck 250 ml flask equipped magnetic bar, which is thoroughly purged with anhydrous nitrogen, 7.5 g of magnesium ethoxide, and 70 ml of anhydrous toluene was introduced to form a suspension. 2.5 mmol of tetramethylurea, 2.0 mmol of dicyclopentyldimethoxysilane, 2.0 mmol of diethylaminotriethoxysilane, 5.0 mmol of diisobutylphthalate and 5.0 mmol of 2-isopentyl-2-isopropyl-dimethoxypropane were charged and then 20 ml of TiCl4 was added. The temperature of the mixture was gradually raised to 110° C., and maintained for 2 hours with stirring. The resulting solid was precipitated and supernatant liquid was decanted. The solid was washed twice with 100 ml of anhydrous toluene at 90° C., and then 80 ml of fresh anhydrous toluene and 20 ml TiCl₄ was added to the filtered solid. Temperature of the mixture was heated to 110° C., and stirred for 2 hours. The solid was precipitated and supernatant liquid was decanted and residual solid was washed with heptane 7 times at 70° C. The final catalyst was collected and dried under vacuum to obtain a solid catalyst component (A1). Silane and internal donor composition are recorded in Table 1.

### (B) Propylene Bulk Phase Polymerization

Propylene polymerization was conducted in a bench scale 2 liter reactor per the following procedure. The reactor was first preheated to at least 100° C. with a nitrogen purge to remove residual moisture and oxygen. The reactor was thereafter cooled to room temperature. Under nitrogen, 2.5 ml of triethylaluminum (0.6M, in hexanes), 0.25 mmol of diisopropyldimethoxysilane and 8 mg of solid catalyst component (A1) prepared above were charged. After addition of various hydrogen to control MFR of polymer and 1.2 liter of liquefied propylene, temperature was raised to 70° C., to start polymerization. The polymerization was conducted for 1 hour at 70° C. The polymer was evaluated for melt flow rate (MFR), heptane insoluble (HI %). The activity of catalyst (AC) was also measured. The polymerization results are recorded in Table 2.

### Example 2

A solid catalyst component (A2) was prepared in the same manner as in Example 1, except that 3.0 mmol of dicyclopentyldimethoxysilane and 1.0 mmol of diethylaminotriethoxysilane were added. The final catalyst was collected and dried under vacuum to obtain a solid catalyst component (A2). Propylene polymerization was carried out in the same manner as described in Example 1, except that solid catalyst component (A2) was charged instead of solid catalyst component (A1). Silane and internal donor composition are summarized Table 1 and polymerization results are listed in Table 2.

### Comparative Example 1

A solid catalyst component (C1) was prepared in the same manner as in Example 1, except that only 3.0 mmol of dicyclopentyldimethoxysilane was added. The final catalyst was collected and dried under vacuum to obtain a solid catalyst component (C1). Propylene polymerization was carried out in the same manner as described in Example 1, except that solid catalyst component (C1) was charged instead of solid catalyst component (A1). Silane and internal donor composition are summarized Table 1 and polymerization results are listed in Table 2.

### Comparative Example 2

A solid catalyst component (C2) was prepared in the same manner as in Example 1, except that only 3.0 mmol of diethylaminotriethoxysilane was added. The final catalyst was collected and dried under vacuum to obtain a solid catalyst component (C2). Propylene polymerization was carried out in the same manner as described in Example 1, except that solid catalyst component (C2) was charged instead of solid catalyst component (A1). Silane and internal donor composition are summarized Table 1 and polymerization results are listed in Table 2.

### Comparative Example 3

A solid catalyst component (C3) was prepared in the same manner as in Example 1, except that silane components was not added. The final catalyst was collected and dried under vacuum to obtain a solid catalyst component (C3). Propylene polymerization was carried out in the same manner as described in Example 1, except that solid catalyst component (C3) was charged instead of solid catalyst component (A1). Silane and internal donor composition are summarized Table 1 and polymerization results are listed in Table 2.

TABLE 1
Silane components & internal donor composition
in solid Catalyst Components

| | U donor | D donor | TMU | DiBP | IIDMP | |
|---|---|---|---|---|---|---|
| | (mmol) | (mmol) | (mmol) | (mmol) | (mmol) | |
| Catalyst A1 | 2.0 | 2.0 | 2.5 | 5.0 | 5.0 | 1072 |
| Catalyst A2 | 1.0 | 3.0 | 2.5 | 5.0 | 5.0 | 1077 |
| Catalyst C1 | 0.0 | 3.0 | 2.5 | 5.0 | 5.0 | 1071 |
| Catalyst C2 | 3.0 | 0.0 | 2.5 | 5.0 | 5.0 | 1073 |
| Catalyst C3 | 0.0 | 0.0 | 2.5 | 5.0 | 5.0 | 1036 |

TABLE 2
Polymerization Summary

| | | Ext. | | | |
|---|---|---|---|---|---|
| | Catalyst | Donor | MFR | | |
| Example | Component | (mmol) | (g/10 min) | Yield (g) | Hi %* |
| Ex. 1 | A1 | P (0.4) | 119.8 | 279.4 | 98.3 |
| | | | 218.8 | 250.3 | 98.1 |
| Ex 2 | A2 | P (0.4) | 147.6 | 261.5 | 98.4 |
| | | | 163.0 | 216.2 | 98.3 |
| Com Ex 1 | C1 | P (0.4) | 71.4 | 287.8 | 98.0 |
| | | | 144.8 | 299.6 | 97.9 |
| Com Ex 2 | C2 | P(0.4) | 80.9 | 309.8 | 97.8 |
| | | | 267.7 | 282.6 | 97.5 |
| Com Ex 3 | C3 | P(0.4) | 132.6 | 225.8 | 97.6 |
| | | | 294.1 | 223.2 | 96.6 |

As shown from the above results, the catalyst components (A1) and (A2) according to present invention employing both dicyclopentyl dimethoxysilane (D donor) and diethylamino triethoxysilane (U donor), and internal donors of tetramethyurea, diisobutylphthalate and 1,3-diether, has produced polypropylene with higher isotacticity (Hi %=98.1˜98.4%) at high MFR (=119.8˜218.8) than that (Hi %=97.9 at 144.8 MFR) of comparative catalyst components (C1) that contain only dicyclopentyldimethoxysilane (D donor), or that of C2 (Hi %=97.5˜97.8% at 80.9˜267.7 MFR) that contains only diethylaminotriethoxysilane (U donor) or that (Hi %=96.6˜97.6% at 132.6˜294.1 MFR) of C3 that does not contain D donor or U donor in its solid catalyst composition.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Whenever a numerical range with a lower limit and an upper limit is disclosed, any number falling within the range is specifically disclosed. Moreover, the indefinite articles “a” or “an”, as used in the claims, are defined herein to mean one or more than one of the element that it introduces.

What is claimed is:

1. A solid catalyst component for the polymerization or co-polymerization of alpha-olefin comprising:
one or more dicyclopentyldialkoxysilane compounds;
one or more diakylaminotrialkoxysilane compounds; and
one or more internal electron donors selected from urea compounds, phthalate compounds, and 1,3-diether compounds.

2. The solid catalyst component of claim 1, wherein the one or more dicyclopentyldialkoxysilane compounds is selected from the compound represented by Formula I:
R₂Si(OR¹)₂ [Formula I]
wherein R is cyclopentyl or its derivatives, and R¹ is aliphatic hydrocarbon having 1 to 20 carbon atoms.

3. The solid catalyst component of claim 1, wherein the one or more diakylaminotrialkoxysilane compounds is selected from the compound represented by Formula II:
(R²)₂NSi(OR³)₃ [Formula II]
wherein R² and R³ are aliphatic hydrocarbons having 1 to 20 carbon atoms.

4. The solid catalyst component of claim 1, wherein the one or more urea compounds is selected from the compound represented by Formula III:
R⁴(R⁵)N(C═O)N(R⁶)R⁷ [Formula III]
wherein R⁴, R⁵, R⁶, and R⁷, which may be identical or different, are independently selected from hydrogen, an aliphatic hydrocarbon group having 1 to 20 carbon atoms, an alicyclic hydrocarbon group having 3-20 carbon atoms, an aromatic hydrocarbon group having 6-20 carbon atoms, or a heteroatom-containing hydrocarbon group having 1 to 20 carbon atoms, wherein two or more of R⁴, R⁵, R⁶, and R⁷ may be linked to form one or more saturated or unsaturated monocyclic or polycyclic rings.

5. The solid catalyst component of claim 1, wherein the one or more dicyclopentyldialkoxysilane compounds are selected from dicyclopentyldimethoxysilane, dicyclopentyldiethoxysilane, dimethylcyclopentyldimethoxysilane, and dicyclopentyldiethoxysilane.

6. The solid catalyst component of claim 1, wherein the one or more dialkylaminotrialkoxysilane compounds are selected from diethylaminotriethoxysilane, dipropylaminotriethoxysilane, and diethylaminotrimethoxysilane.

7. The solid catalyst component of claim 1, wherein the urea compounds are selected from N,N,N′,N′-tetramethylurea, N,N,N′,N′-tetraethylurea, N,N,N′,N′-tetrapropylurea, N,N,N′,N′-tetrabutylurea, N,N,N′,N′-tetrapentylurea, N,N,N′,N′-tetrahexylurea, N,N,N′,N′-tetra(cyclopropyl)urea, N,N,N′,N′-tetra(cyclohexyl)urea, N,N,N′,N′-tetraphenylurea, bis(butylene)urea, bis(pentylene)urea, N,N′-dimethylethyleneurea, N,N′-dimethylpropyleneurea, dipropyl-2-imidazolidinone, 1,3-dibutyl-2-imidazolidinone, 1,3-dimethyl-3,4,5,6-tetrahydro-2-pyrimidinone, and N,N-dimethyl-N,N,-diphenylurea.

8. The solid catalyst component of claim 1, wherein the phthalate compounds are selected from diethylphthalate, di-n-propylphthalate, di-n-butylphthalate, di-n-pentylphthalate, di-i-pentylphthalate, bis(2-ethylhexyl)phthalate, ethylisobutylphthalate, ethyl-n-butylphthalate, di-n-hexylphthalate, and di-isobutylphthalate.

9. A method for polymerizing alpha-olefins, comprising:
providing a solid catalyst component comprising:
one or more dicyclopentyldialkoxysilane compounds;
one or more diakylaminotrialkoxysilane compounds; and
one or more urea compounds; and
providing a co-catalyst component comprising an organoaluminum compound;
reacting the alpha-olefins with the solid catalysts component and the co-catalyst component to form a polyolefin.

10. The method of claim 9, further comprising providing one or more external electron donor compounds, and reacting the alpha-olefins with the solid catalysts component, the co-catalyst component, and the one or more external electron donor compounds to form a polyolefin.
